(19) United States
(12) Patent Application Publication
(10) Pub. No.: US 2004/0228114 A1
(43) Pub. Date: Nov. 18, 2004

(54) Luminescent toolbox apparatus

(76) Inventor: Terence Chen, Yi Lan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/459,954

(22) Filed: Jun. 12, 2003

(30) Foreign Application Priority Data
May 14, 2003 (TW) 92113016

(51) Int. Cl. F21V 9/16

(52) U.S. Cl. 362/84

(57) ABSTRACT

A luminescent toolbox apparatus includes a toolbox and a luminescent device attached to the toolbox in order to provide luminescence. The luminescent device includes a driver, a sensor connected with the driver and a light source connected with the driver. The driver turns on the light source as it receives a signal from the sensor.

### FIELD OF INVENTION

The present invention relates to a luminescent toolbox apparatus.

### BACKGROUND OF INVENTION

Taiwanese Patent Publication No. 347741 discloses an illuminative toolbox apparatus including a toolbox 10, a light 20 and a magnet 30. The toolbox 10 defines recesses 112 and 122 for receiving tools. The light 20 includes a shell 21 for receiving a light bulb 24 and batteries 22. The magnet 30 is secured to the shell 21 so that the light 20 can be attached, via magnetic attraction, to ferromagnetic elements including the toolbox 10. The batteries 22 cannot power the light bulb 24 for long. Moreover, it is difficult to find the toolbox 10 in a storage room full of miscellaneous articles, and more so in a power failure.

The present invention is therefore intended to obviate or at least alleviate the problems encountered in prior art.

### SUMMARY OF INVENTION

The primary objective of the present invention is to provide a luminescent toolbox apparatus that provides luminescence when necessary.

According to the present invention, a luminescent toolbox apparatus includes a toolbox and a luminescent device attached to the toolbox in order to provide luminescence.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a luminescent toolbox apparatus according to a first embodiment of the present invention.

FIG. 2 is an exploded view of the luminescent toolbox apparatus of FIG. 1.

FIG. 3 is a top view of the luminescent toolbox apparatus of FIG. 1.

FIG. 4 is similar to FIG. 1 but showing the luminescent toolbox apparatus emitting luminescent light.

FIG. 5 is a perspective view of a luminescent toolbox apparatus according to a second embodiment of the present invention.

FIG. 6 is a perspective view of a luminescent toolbox apparatus according to a third embodiment of the present invention.

### DETAILED DESCRIPTION OF EMBODIMENTS

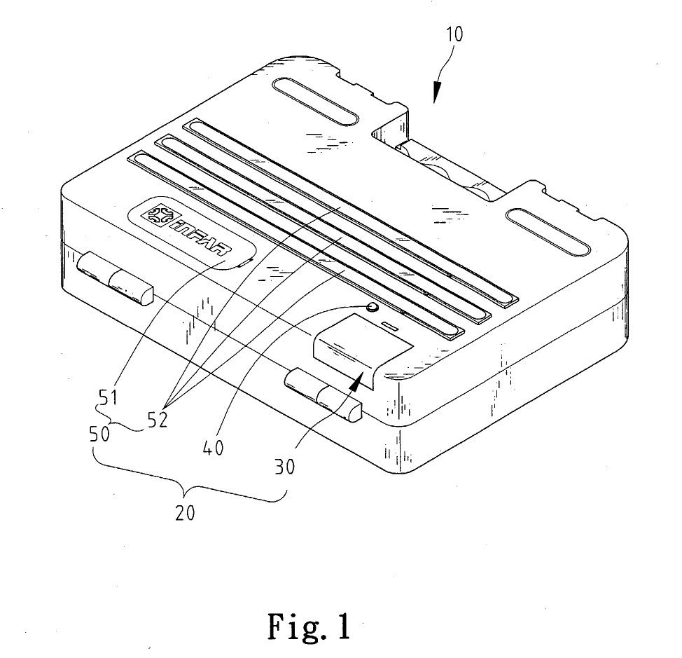

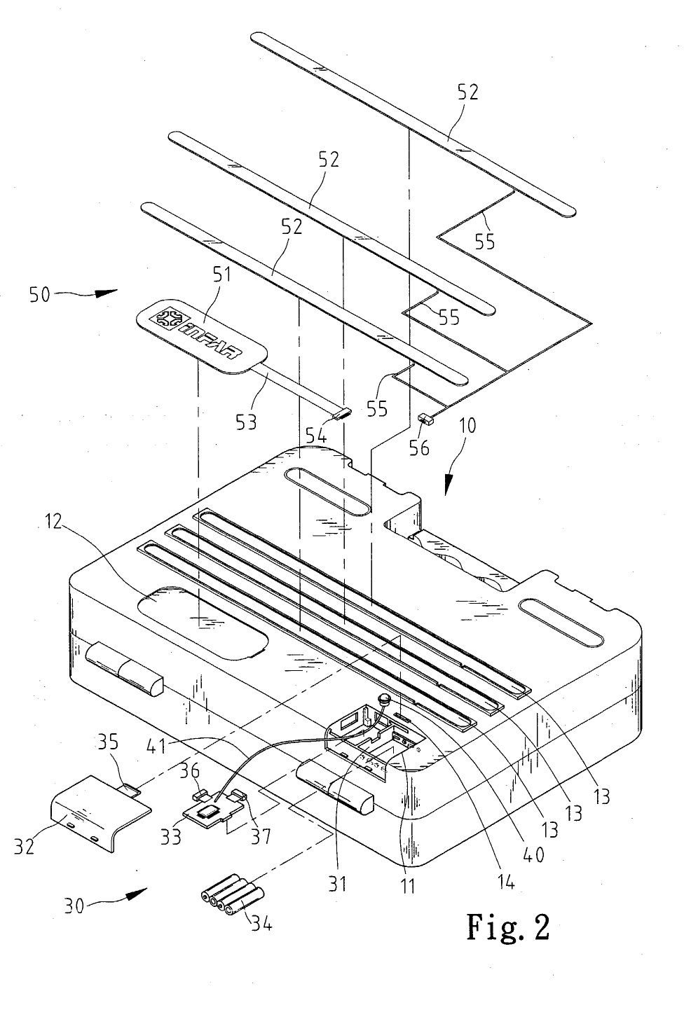

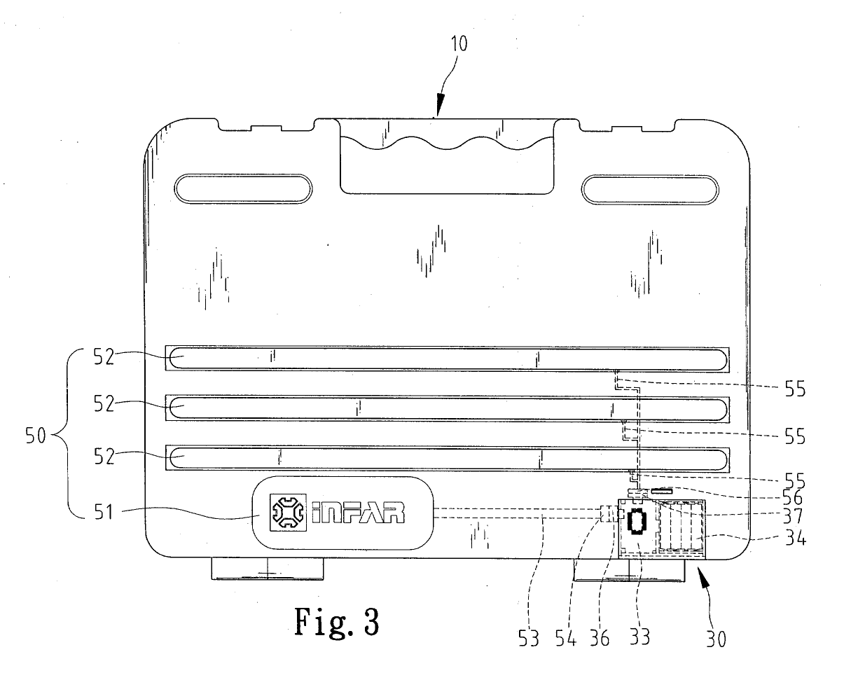

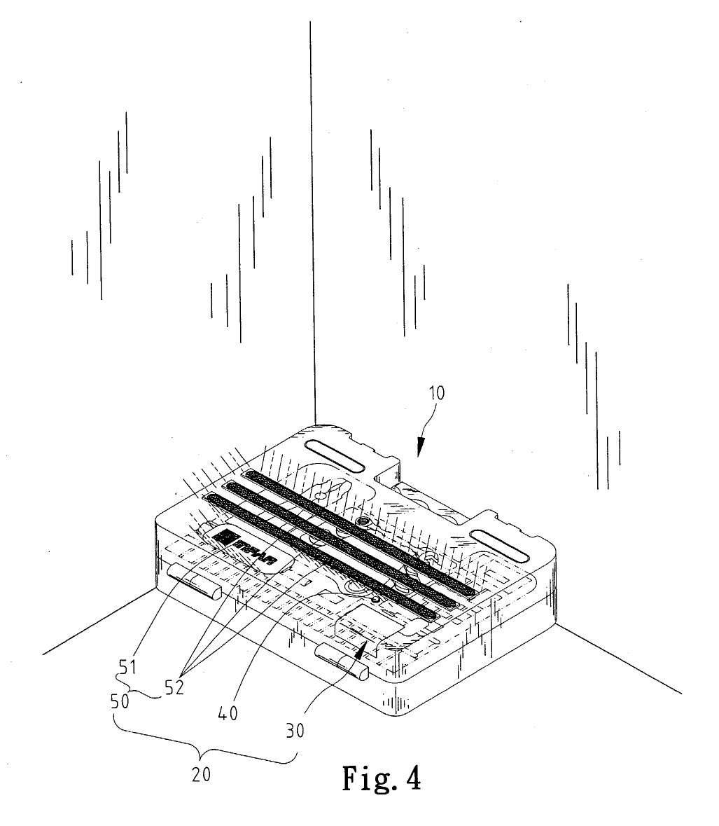

Referring to FIGS. 1-4, according to a first embodiment of the present invention, a luminescent toolbox apparatus includes a toolbox 10 and a luminescent device 20 attached to the toolbox 10 in order to provide luminescence.

The toolbox 10 defines recesses 11, 12 and 13 and a slot 14 near the recess 11. The toolbox 10 is otherwise similar to conventional toolboxes and therefore will not be described in detail.

The luminescent device 20 includes a driver 30, a sensor 40 connected with the driver 30 and a light source 50 connected with the driver 30. In a preferred operation, the driver 30 does not turn on the light source 50 unless it receives a signal from the sensor 40.

The driver 30 includes a case 31 fit in the recess 11, a cover 32 for closing the case 31, a control unit 33 put in the case 31 and a power supply 34 put in the case 31 and electrically connected with the control unit 33. The cover 32 includes a buckle 35 extending from an edge thereof. As the case 31 is completely closed by means of the cover 32, the buckle 35 is inserted in the slot 14, thus retaining the case 31 closed by means of the cover 32. The control unit 33 may be implemented as a circuit board. The control unit 33 includes terminals 36 and 37. The power supply 34 may include a plurality of batteries.

The sensor 40 is electrically connected with the control unit 33 through a wire 41. The sensor 40 may be an optical sensor. As the brightness of the environment around the sensor 40 falls below a limit, the sensor 40 sends a signal to the control unit 33 so that the control unit 33 turns on the light source 50. On the contrary, as the brightness of the environment around the sensor 40 rises above the limit, the sensor 40 does not send a signal to the control unit 33 so that the control unit 33 turns off the light source 50. In another embodiment, the sensor 40 may be an acoustic sensor that sends a signal to the control unit 33 after sensing a clap.

The light source 50 includes a luminescent strip 51 and three luminescent strips 52. The luminescent strip 51 is put in the recess 12. The luminescent strip 51 may carry a logo. A wire 53 leads from the luminescent strip 51 to a terminal 54. The terminal 54 can be brought to engagement with the terminal 36 for electric connection of the luminescent strip 51 with the control unit 33. Each of the luminescent strips 52 is put in one of the recesses 13. Each of the luminescent strips 52 is electrically connected with a wire 55. The wires 55 lead to a terminal 56. The terminal 56 can be brought to engagement with the terminal 37 for electric connection of the luminescent strips 52 with the control unit 33. The control unit 33 may cause the luminescent strips 51 and 52 to emit luminescence synchronously or by turns. The control unit 33 may cause each of the luminescent strips 51 and 52 to emit luminescence continuously or flash.

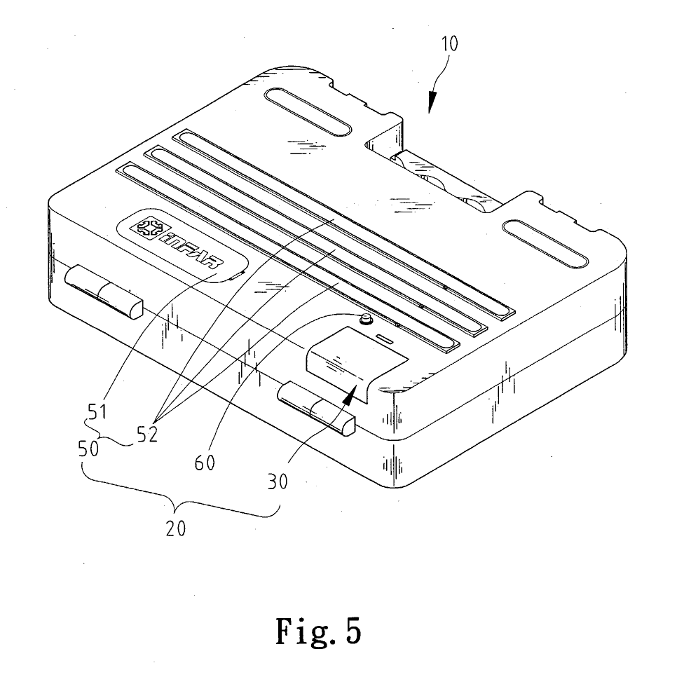

FIG. 5 shows a luminescent toolbox apparatus according to a second embodiment of the present invention. The second embodiment is identical to the first embodiment except for including a switch 60 instead of the sensor 40.

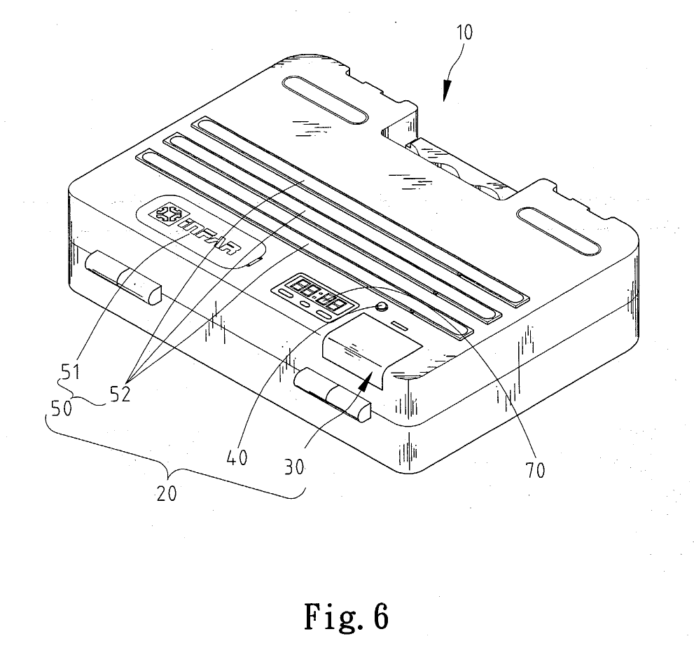

FIG. 6 shows a luminescent toolbox apparatus according to a third embodiment of the present invention. The third embodiment is identical to the first embodiment except for including a timer 70 connected with the control unit 33. By means of the timer 70, a period of time can be set in which the control unit 33 turns on the light source 50 after receiving the signal.

The present invention has been described via detailed illustration of some embodiments. Those skilled in the art can derive many variations from the embodiments without departing from the scope of the present invention. Therefore, the embodiments shall not limit the scope of the present invention defined in the claims.

In the claims:

1. (canceled).

2. A luminescent toolbox apparatus including a toolbox and a luminescent device attached to the toolbox in order to provide luminescence, wherein the luminescent device includes a driver, a sensor connected with the driver and a light source connected with the driver so that the driver turns on the light source as it receives a signal from the sensor.

3. The luminescent toolbox apparatus according to claim 2 wherein the driver includes a case attached to the toolbox, a cover for closing the case, a control unit put in the case and a power supply put in the case and connected with the control unit.

4. The luminescent toolbox apparatus according to claim 3 wherein the cover includes a buckle extending from an edge thereof for insertion in a slot defined in the toolbox as the case is closed by means of the cover, thus retaining the case closed by means of the cover.

5. The luminescent toolbox apparatus according to claim 3 wherein the control unit includes a circuit board.

6. The luminescent toolbox apparatus according to claim 3 wherein the power supply includes a plurality of batteries.

7. The luminescent toolbox apparatus according to claim 3 wherein the toolbox defines a recess for receiving the case.

8. The luminescent toolbox apparatus according to claim 2 wherein the sensor is an optical sensor that sends the signal to the driver as the brightness of the environment around the sensor falls below a limit.

9. The luminescent toolbox apparatus according to claim 2 wherein the sensor is an acoustic sensor that sends the signal to the driver after sensing a clap.

10. The luminescent toolbox apparatus according to claim 2 wherein the light source includes at least one luminescent strip.

11. The luminescent toolbox apparatus according to claim 9 wherein the driver causes the at least one luminescent strip to emit luminescence continuously.

12. The luminescent toolbox apparatus according to claim 10 wherein the driver causes the at least one luminescent strip to flash.

13. The luminescent toolbox apparatus according to claim 10 wherein the light source includes a plurality of luminescent strip.

14. The luminescent toolbox apparatus according to claim 13 wherein the driver causes the luminescent strips to emit luminescence synchronously.

15. The luminescent toolbox apparatus according to claim 13 wherein the driver causes the luminescent strips to emit luminescence by turns.

16. The luminescent toolbox apparatus according to claim 10 wherein the driver includes at least one terminal, and the light source includes at least one wire leading from the at least one luminescent strip to a terminal for engagement with the at least one terminal of the driver.

17. The luminescent toolbox apparatus according to claim 10 wherein the toolbox defines at least one recess for receiving the at least one luminescent strip.

18. The luminescent toolbox apparatus according to claim 10 wherein the at least one luminescent strip carries a logo.

19. The luminescent toolbox apparatus according to claim 2 including a timer connected with the driver for setting a period of time can be set in which the driver turns on the light source after receiving the signal.

20. The luminescent toolbox apparatus according to claim 2 wherein the luminescent device includes a switch connected with the driver, with the driver turning on the light source as it receives a signal from the switch.
